(19) United States
(12) Patent Application Publication
(10) Pub. No.: US 2007/0296697 A1
(43) Pub. Date: Dec. 27, 2007

(54) Wireless cursor indicating device

(75) Inventor: Jerry Chen, Taipei (TW)

Correspondence Address: BACON & THOMAS, PLLC, 625 SLATERS LANE, FOURTH FLOOR, ALEXANDRIA, VA, 22314, US

(73) Assignee: ARESON TECHNOLOGY CORP., TAIPEI (TW)

(21) Appl. No.: 11/474,376

(22) Filed: Jun. 26, 2006

(51) Int. Cl. G09G 5/08

(52) U.S. Cl. 345/158

(57) ABSTRACT

A wireless cursor indicating device includes a first body and a second body combined with each other. The first body includes a containing space for containing a control circuit and a wireless receiver, and both sides of the first and second bodies include a sliding track and a sliding groove embedded with each other, and an elastic member and a limit member are embedded between the first and second bodies, so that the first and second bodies can be slid with respect to each other by means of the sliding track and sliding groove to define an OFF state or an ON state. With the operation of the elastic member and limit member, the first and second bodies in the ON state can be pulled by the elastic member without being disposed alternately, and only the containing space will be exposed for an easy access by users.

### BACKGROUND OF THE INVENTION

1. Field of the Invention

The present invention relates to a wireless cursor indicating device, and more particularly to a wireless cursor indicator device wherein a first body and a second body are slidably coupled and stacked with each other to define an OFF state, and the first and second bodies are disposed alternately with each other to define an ON state such that only a containing space for containing an object is exposed by the action of an elastic member and a limit member at the ON state, and the resilience of the elastic member can be used to restore the OFF state.

2. Description of the Related Art

As mice have become a necessary computer peripheral, and a presentation indicator for controlling the operation of a computer also becomes a very important tool to a speaker or a presenter. In early days, a mouse must be connected to a computer through a transmission line for operating and controlling a computer, and such mouse is called a cable mouse. However the mice of this type are very inconvenient because the transmission line is always in the way, and the mouse cannot be placed at an appropriate position for its operation according to a user's habits. The presentation indicator can only project a light spot on a computer screen, such that if it is necessary to change the data displayed on the screen, the users have to use a mouse to display the changed data on the screen.

To overcome the foregoing shortcomings, a wireless cursor indicator was introduced, and the wireless cursor indicator includes a wireless receiver connected to a computer by a transmission line (such as a USB cable), so that the control signals of the computer can be transmitted through the transmission line to the wireless receiver. With the wireless receiver and wireless cursor indicator, the wireless cursor indicator includes a transmitter for sending the operating signal of the wireless cursor indicator to the wireless receiver, and the wireless receiver connects the computer and sends signals to the computer. In the meantime, the wireless cursor indicator also installs a light source to indicate the data on the computer screen, and the wireless cursor indicator installs two batteries for supplying the required power for the operation of the transmitter. Although the foregoing arrangement can improve the problems of the cable mouse or cursor indicator, the wireless receiver is a separate electronic part and cannot be integrated with the mouse or cursor indicator, and thus it makes the storage inconvenient. Although some existing wireless mice or cursor indicators provide a containing space and a latch at the bottom of the mouse or cursor indicator for accommodating and fixing the receiver therein. However, the application still has the problem that the receiver may be fallen out or protruded from the wireless mouse or cursor indicator.

### SUMMARY OF THE INVENTION

In view of the shortcomings of the prior art, the inventor of the invention based on years of experience in the related industry to conduct extensive researches and experiments, and finally developed a wireless cursor indicating device in accordance with the present invention.

Therefore, it is a primary objective of the present invention to provide a feasible solution and overcome the foregoing problems by providing a wireless cursor indicating device that is comprised of a first body and a second body, and a first body includes a containing space disposed at an appropriate position for containing a control circuit and a wireless receiver, and a sliding groove and a sliding track are embedded at both ends of the first and second bodies. Further, an elastic member is installed between the first and second bodies, and an end of the elastic member is fixed to the first body and another end of the elastic member is fixed to the second body, such that the first and second bodies can be slidably coupled with each other by the sliding groove and the sliding track and stacked with each other to define an OFF state. With the operation of the elastic member and the limit member, the first and second bodies are not alternately disposed with each other to define an ON state, and only the containing space for containing objects is exposed at the ON state. Further, the resilience of the elastic member can be used to restore the OFF state, and thus such arrangement can achieve the effects for storing objects conveniently, and accommodating objects properly without exposing the objects.

Another objective of the present invention is to provide a wireless cursor indicating device, and its first and second bodies separately include a corresponding limit member, such that when the first and second bodies are stacked, the limitation provided by limit member can prevent the first and second bodies from sliding with respect to each other.

A further objective of the present invention is to provide a wireless cursor indicating device, and its first and second bodies separately include an electric connector, such that when the first and second bodies are stacked at an OFF state, the electric connectors can electrically connect the circuits of the first and second bodies. On the other hand, the circuits are disconnected at an ON state.

Another objective of the present invention is to provide a wireless cursor indicating device, and its first and second bodies separately include an electric connector, such that an electric circuit is used for connecting the electric connectors and maintaining the first and second bodies electrically connected when they are stacked at an OFF state or disposed alternately at an ON state.

### BRIEF DESCRIPTION OF THE DRAWINGS

The objective, shape, structure, characteristic and effect of the present invention will now be described in more detail with reference to the accompanying drawings that show various embodiments of the invention, in which:

FIG. 1 is an exploded view of the invention;

FIG. 1A is an exploded view of another preferred embodiment of the invention;

FIG. 2 is an exploded view of a first body of the invention;

FIG. 3 is a schematic view of an OFF state of the invention;

FIG. 4 is a cross-sectional view of an OFF state of the invention;

FIG. 5 is a schematic view of placing objects in an ON state and alternately disposed with each other according to the invention;

FIG. 6 is a cross-sectional side view of operating a limit member in an ON state;

FIG. 6A is an enlarged view of FIG. 6; and

FIG. 7 is a cross-sectional side view of the operation of a limit member in a stacked status according to the invention.

### DETAILED DESCRIPTION OF THE PREFERRED EMBODIMENTS

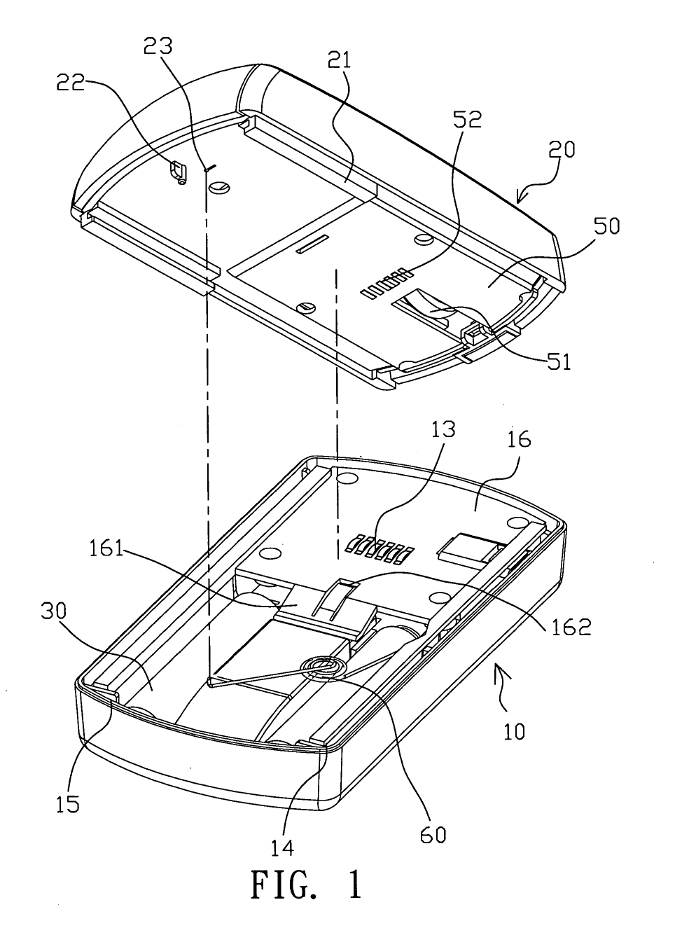

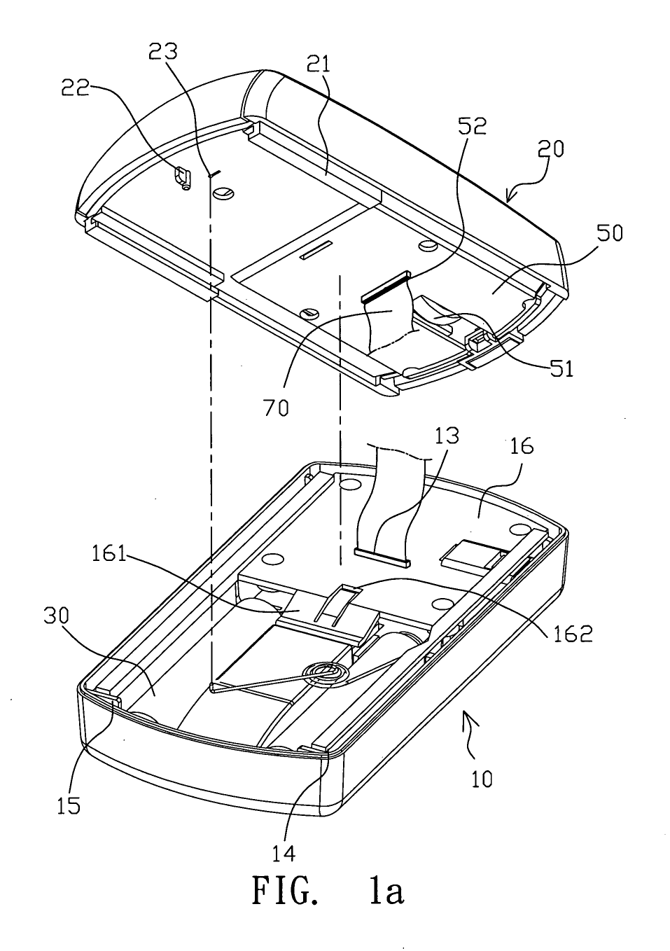

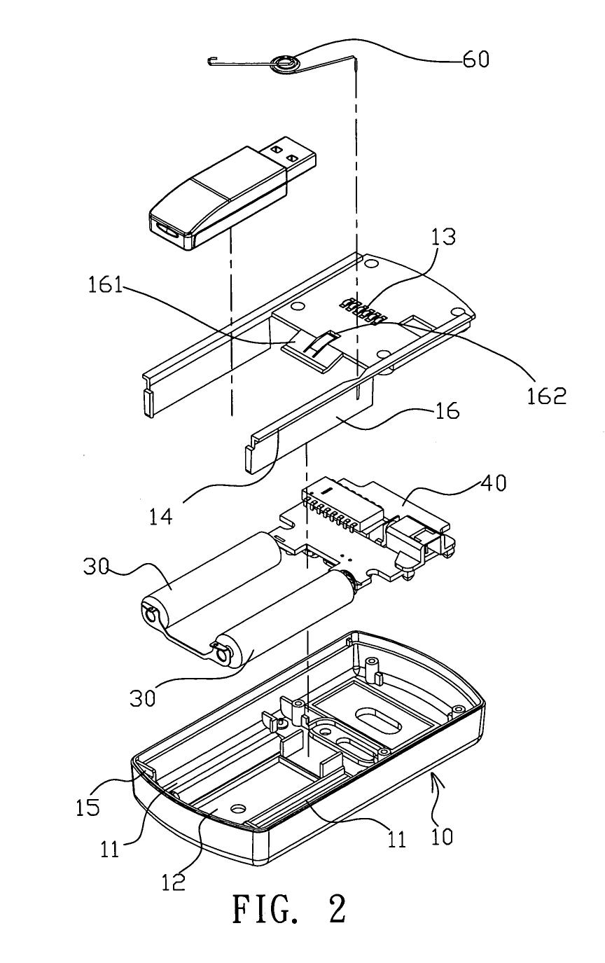

Referring to FIGS. 1 and 2 for a wireless cursor indicating device (which is a wireless mouse in this embodiment, but the persons skilled in the art also could use an indicating cursor to substitute the wireless mouse), the wireless cursor indicating device is comprised of first and second bodies 10, 20 with a corresponding shape. In FIG. 2, the first body 10 includes a battery accommodating space 11 for containing a battery 30 to supply the required power supply, and the first body 10 includes a containing space 12 in the accommodating space 11 for containing an object such as a wireless receiver or any other electronic part, and the first body 10 includes a control circuit 40 in other space, and the control circuit in this embodiment is an optical control circuit board, but the persons skilled in the art can install related circuits the control circuit. The optical control circuit 40 includes a frame 16 pressing against the surface of the optical control circuit 40, and the frame 16 includes an elastic pressing member 161 extended towards the containing space 12 and a groove 162 for fixing an object such as a wireless receiver or other electronic parts. Further, the frame 16 includes an electric connector 13 coupled to the optical control circuit 40 and battery 30, and the first body 10 includes parallel sliding grooves 14 or sliding tracks on both sides of the frame 16. The first body 10 includes a limit member 15 disposed at an edge of the first body 10, and the limit member is a protruding blocking plate in this embodiment, but the persons skilled in the art can substitute the protruding blocking plate by another appropriate component.

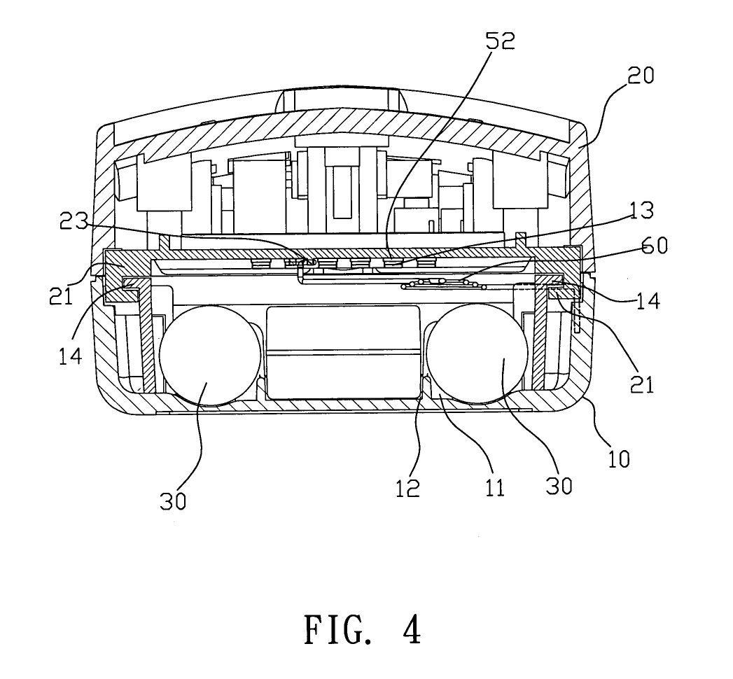

In FIG. 1, the second body 20 includes a sliding track 21 or sliding groove disposed separately on both sides of the second body 20 corresponding to the sliding groove 14 or sliding track of the first body 10 for slidably embedding the first and second bodies 10, 20, and the second body 20 includes a limit member 22 disposed on a surface corresponding to the first body 10. The limit member 22 is a protrusion in this embodiment, but the persons skilled in the art can substitute the protrusion with another appropriate element. The limit member 22 works in conjunction with a groove 162 of the first body 10 to provide a limitation when the first and second bodies 10, 20 are slidably and alternately disposed, and the second body 20 also includes a control unit 50 and a roller 51 disposed at a position corresponding to the control circuit 40 of the first body 10, and the control unit 50 installs an electric connector 52 connected to the control unit 50, such that the electric connectors 13, 52 are in contact with each other or an electric circuit 70 is connected between the electric connectors 13, 52 as shown in FIG. 1A when the control unit 50 is in use, and the control circuit 40 and power supply on the first body 10 are electrically connected with the control unit 50 on the second body 20 as shown in FIG. 4 for driving the wireless mouse, and its operation is similar to that of a general wireless mouse, which is a prior art and thus will not be described here.

Further, an elastic member 60 (which is a spring in this embodiment) is installed between the first and second bodies 10, 20, and an end of the elastic member 60a is latched between the accommodating space 11 and the sliding groove 14, and another end of the elastic member 60a is latched into an embedding groove 23 of the second body 20, and the embedding groove 23 is basically disposed alternately with the first body 10.

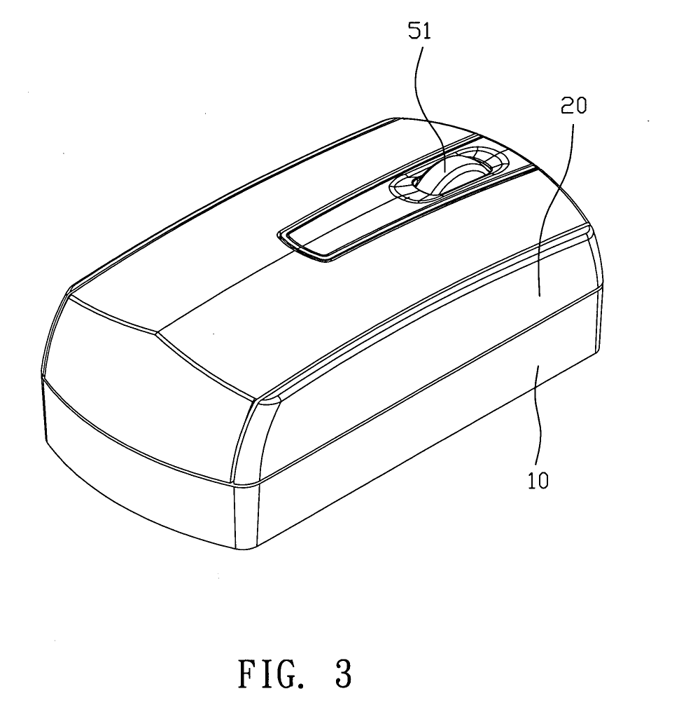

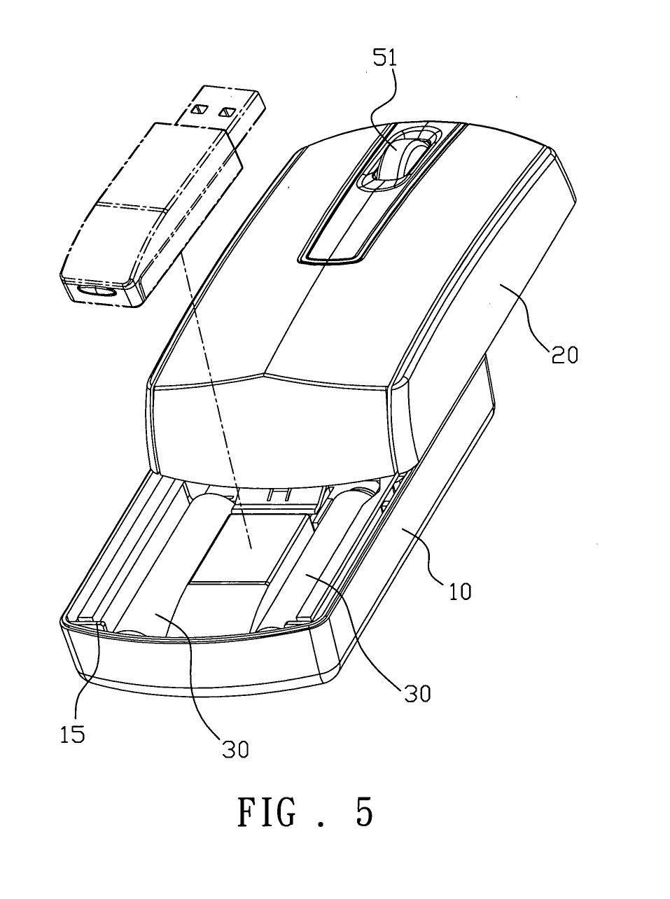

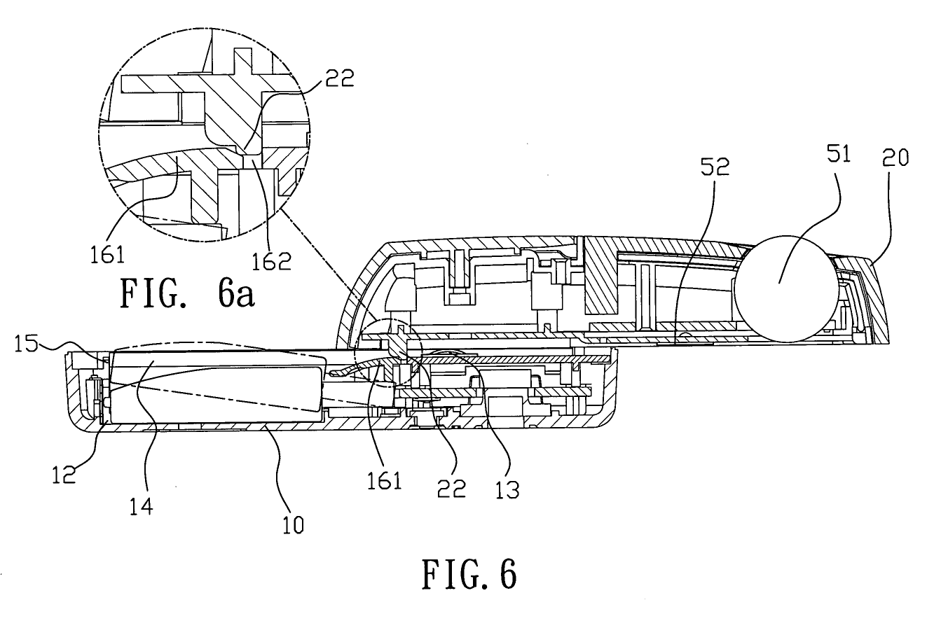

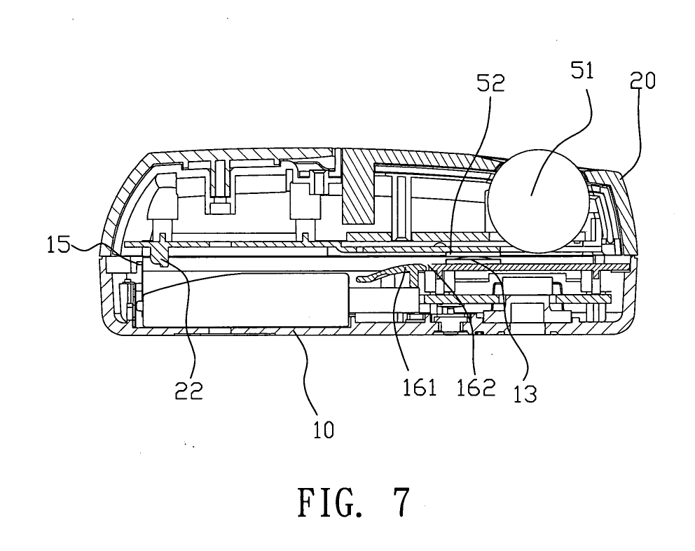

Referring to FIGS. 3 to 7 for an application, the sliding groove 14 and the sliding track 21 are embedded with each other, and a distal edge of the sliding track 21 is pressed and fixed by the limit member 15, such that the first and second bodies 10, 20 can be stacked to define an OFF state as shown in FIG. 3. In the OFF state, the electric connectors 13, 52 of the first and second bodies 10, 20 are in contact with each other, and the power supply, control circuit 40 and control unit 50 are electrically connected as shown in FIG. 4. If a user wants to access an object (which is a wireless receiver in this embodiment) in the first body 10 or install or change a battery, the user can push the second body 20 forward at an OFF state, such that the second body 20 can be moved along the sliding track 21, and the elastic member 60 can be extended into a coiled status. If the second body 20 continues to move along the sliding track 21, the elastic member 60 will be uncoiled until the accommodating space 11 and containing space 12 are exposed, so that the second body 20 is disposed alternately with the first body 10 to define an ON state and facilitate the user to place or remove an object or change a battery 30. In the ON state, the elastic member 60 presses the limit member 22 on the second body 20 and the groove 162 on the frame 16 to restrict the second body 20 from continuing to slide, such that the first and second bodies 10, 20 will not be disposed alternately at the ON state, but the containing space 12 will be exposed as shown in FIGS. 5 and 6, and the resilience of the elastic member 60 can restore the OFF state. If the first and second bodies 10 are restored to the OFF state, the limit member 15 restricts the distal edge of the sliding track 21 (not shown in the figure) to achieve the positioning effect, and thus the first and second bodies 10, 20 will be stacked as shown in FIG. 7.

In summation of the description above, the object, shape, structure of the present invention are novel and improve over the prior art and thus is duly submitted for the patent application. While the invention has been described by means of specific embodiments, modifications and variations could be made by those skilled in the art without departing from the scope and spirit of the invention set forth in the claims.

What is claimed is:

1. A wireless cursor indicating device, comprising:
a first body, including a containing space for containing a control circuit and a wireless receiver and a sliding groove or a sliding track disposed on said first body;
a second body, embedded onto said first body and including a sliding track or a sliding groove, such that said second body can be embedded with said first body by said sliding track and said sliding groove and slid on said first body;
an elastic member, latched between said first and second bodies and having an end fixed to said first body and another end fixed to said second body, and both ends being disposed alternately with each other;
thereby, said first and second bodies can be stacked to define an OFF state by means of said sliding track and said sliding groove, or said first and second bodies are limited by an elastic member from being disposed alternately with each other to define an ON state and only a containing space for containing objects is exposed, and the resilience of said elastic member can restore said OFF state.

2. The wireless cursor indicating device of claim 1, wherein said wireless cursor indicating device is a wireless mouse.

3. The wireless cursor indicating device of claim 1, wherein said elastic member is a spring.

4. The wireless cursor indicating device of claim 1, wherein said first body includes a limit member disposed at a distal edge of said first body, such that when said first and second bodies are stacked, said limit member presses and limits a distal edge of said sliding track or sliding groove of said second body for preventing said first and second bodies from sliding with respect to each other.

5. The wireless cursor indicating device of claim 1, wherein said first body includes a frame for pressing against a surface of said control circuit, and said frame includes an elastic pressing member extended towards said containing space for fixing a wireless receiver.

6. The wireless cursor indicating device of claim 5, wherein said frame includes a groove thereon.

7. The wireless cursor indicating device of claim 6, wherein said second body includes a limit member disposed at a surface corresponding to said first body, such that when said first and second bodies are at an ON state, said first and second bodies are prevented from continuing sliding by means of the pressing and limitation of said limit member and said groove.

8. The wireless cursor indicating device of claims 4 and 7, wherein said limit member is a blocking plate or a protrusion.

9. The wireless cursor indicating device of claim 1, wherein said first and second bodies separately include an electric connector, such that when said first and second bodies are stacked at an OFF state, the circuits of first and second bodies are electrically coupled with each other by said electric connector.

10. The wireless cursor indicating device of claim 1, wherein said first and second bodies separately include an electric connector, and said electric connectors are connected by an electric circuit, such that the circuits of said first and second bodies are electrically coupled with each other.
